(19) United States
(12) Patent Application Publication
(10) Pub. No.: US 2025/0077406 A1
(43) Pub. Date: Mar. 6, 2025

(54) METHOD AND APPARATUS FOR PROCESSING ARTIFICIAL NEURAL NETWORK WITH EFFICIENT MATRIX MULTIPLICATION OPERATION

(71) Applicant: Electronics and Telecommunications Research Institute, Daejeon (KR)

(72) Inventors: Hyun Mi KIM, Daejeon (KR); Chun Gi LYUH, Daejeon (KR)

(73) Assignee: Electronics and Telecommunications Research Institute, Daejeon (KR)

(21) Appl. No.: 18/804,853

(22) Filed: Aug. 14, 2024

(30) Foreign Application Priority Data
Sep. 6, 2023 (KR) 10-2023-0118641
Jun. 21, 2024 (KR) 10-2024-0081204

(51) Int. Cl. G06F 12/02; G06F 17/16

(52) U.S. Cl. CPC G06F 12/0207; G06F 17/16

(57) ABSTRACT

Provided is an artificial neural network processing apparatus including: first to fourth submatrix multiplication operators configured to perform a first submatrix multiplication operation and then a second submatrix multiplication operation using eight pieces of input data; a memory mapping unit configured to map at least a portion of the eight pieces of input data to the first to fourth submatrix multiplication operators with a first mapping structure for the first submatrix multiplication operation, and map at least a portion of the eight pieces of input data to the first to fourth submatrix multiplication operators with a second mapping structure for the second submatrix multiplication operation, wherein the first mapping structure and the second mapping structure have different mapping structures; and a controlling unit configured to control the memory mapping unit to be formed with the first mapping structure or the second mapping structure.

### CROSS-REFERENCE TO RELATED APPLICATION

The present application claims priority to Korean Patent Application No. 10-2023-0118641, filed on Sep. 6, 2023 and Korean Patent Application No. 10-2024-0081204, filed on Jun. 21, 2024, the disclosures of which are incorporated by reference herein in their entireties.

### BACKGROUND

The present disclosure relates to a method and apparatus for processing an artificial neural network with an efficient matrix multiplication operation.

The statements in this section merely provide background information related to the present disclosure and do not necessarily constitute prior art.

FIG. 1 is a diagram illustrating the configuration of a systolic array and a local memory adjacent thereto, which are commonly used in artificial neural network processing apparatuses.

In FIG. 1, in order to perform a matrix multiplication A×B operation using a systolic array 110, matrix A and matrix B are respectively read from adjacent local memories 121 and 122 and sequentially sent to the systolic array 110, and the systolic array 119 uses the same to perform a matrix multiplication operation. As such, the local memories 121 and 122 and the systolic array 110 are very closely connected.

As the size of the systolic array 110 increases, the recycling rate of data input to the systolic array 110 increases, so there is a benefit in that limited input memory bandwidth may be used efficiently. However, when the size of the matrix to be processed is smaller than the size of the systolic array 110, the number of operators (PE) that are not used for operating the matrix input within the systolic array 110 increases, resulting in inefficiencies in operated performance even when the matrix size is small.

FIG. 2 is a diagram conceptually illustrating the structure of an artificial neural network processing apparatus configured of a plurality of artificial neural network processing blocks of a limited size.

In order to address the inefficiency in FIG. 1, the structure of the artificial neural network processing apparatus configured of four artificial neural network processing blocks of a limited size as shown in FIG. 2 may be used.

In FIG. 2, each artificial neural network processing block 210, 220, 230, or 240 includes a corresponding systolic array block 211, 221, 231, or 241 and a local memory 212, 222, 232, or 242.

In the structure of FIG. 2, in order to perform multiplication on a large matrix, the data of the large matrix is divided to fit the size of each systolic array block 211, 221, 231, or 241 and stored respectively in the local memory 212, 222, 232, or 242. Each systolic array block 211, 221, 231, or 241 performs a corresponding local matrix multiplication operation using data from the corresponding local memory 212, 222, 232, or 242.

In this connection, when the matrix multiplication result for the entire matrix is not generated by performing only one local matrix multiplication operation, it is necessary to perform the local matrix multiplication operation once again with a different data combination in each systolic array block 211, 221, 231, or 241.

As such, in order to perform the local matrix multiplication operation once again, data is exchanged between each artificial neural network processing block 210, 220, 230, or 240. Alternatively, when the data required by each artificial neural network processing block 210, 220, 230, or 240 is requested from a memory controller 250, the memory controller 250 reads the data from an external global memory 260 and delivers the same to the artificial neural network processing block 210, 220, 230, or 240 that requires the data.

However, in this process, due to limitations in the bandwidth of the global memory 260 or the interconnection bandwidth between each artificial neural network processing block 210, 220, 230, or 240, decreased efficiency may occur in generating matrix multiplication operation results for the entire matrix.

### SUMMARY

An object of the present disclosure is to provide a method and apparatus for processing an artificial neural network with efficient matrix multiplication operation.

The technical objects of the present disclosure are not limited to those described above, and other technical objects not mentioned above may be understood clearly by those skilled in the art from the descriptions given below.

An embodiment of the present disclosure provides an artificial neural network processing apparatus comprising: first to fourth submatrix multiplication operators which perform a first submatrix multiplication operation and then a second submatrix multiplication operation using eight pieces of input data; a memory mapping unit which maps at least a portion of the eight pieces of input data to the first to fourth submatrix multiplication operators with a first mapping structure for the first submatrix multiplication operation, and maps at least a portion of the eight pieces of input data to the first to fourth submatrix multiplication operators with a second mapping structure for the second submatrix multiplication operation, wherein the first mapping structure and the second mapping structure have different mapping structures; and a controlling unit which controls the memory mapping unit to be formed with the first mapping structure or the second mapping structure.

Another embodiment of the present disclosure provides a method for processing an artificial neural network in an artificial neural network processing apparatus comprising first to fourth submatrix multiplication operators, a memory mapping unit, and a controlling unit, the method comprising: a process of performing a first submatrix multiplication operation and then a second submatrix multiplication operation using eight pieces of input data in the first to fourth submatrix multiplication operators; a memory mapping process in which the memory mapping unit maps at least a portion of the eight pieces of input data to the first to fourth submatrix multiplication operators with a first mapping structure for the first submatrix multiplication operation, and maps at least a portion of the eight pieces of input data to the first to fourth submatrix multiplication operators with a second mapping structure for the second submatrix multiplication operation, wherein the first mapping structure and the second mapping structure have different mapping structures; and a controlling process in which the controlling unit controls the memory mapping unit to be formed with the first mapping structure or the second mapping structure.

As described above, according to an embodiment of the present disclosure, an on-chip memory interconnection hardware structure is provided for efficiently processing matrix multiplication operations, which occupy the largest amount of operations in an artificial neural network processing apparatus.

In addition, by using minimal hardware resources, there are benefits of overcoming the bandwidth limitation of data movement for partitioned matrix multiplication operations and efficiently performing the entire matrix multiplication operation.

The technical effects of the present disclosure are not limited to the technical effects described above, and other technical effects not mentioned herein may be understood to those skilled in the art to which the present disclosure belongs from the description below.

### BRIEF DESCRIPTION OF DRAWINGS

FIG. 1 is a diagram illustrating the configuration of a systolic array and a local memory adjacent thereto, which are commonly used in artificial neural network processing apparatuses.

FIG. 2 is a diagram conceptually illustrating the structure of an artificial neural network processing apparatus configured of a plurality of artificial neural network processing blocks of a limited size.

FIG. 3 is a diagram illustrating the configuration of an artificial neural network processing apparatus according to an embodiment of the present disclosure in functional blocks.

FIG. 4 is a diagram conceptually illustrating a matrix operation of multiplying matrix A and matrix B to acquire output matrix C.

FIG. 5 is a diagram conceptually illustrating a submatrix multiplication operation method for acquiring the output matrix C.

FIG. 6A is a diagram illustrating the mapping structure of a local memory and a submatrix multiplication operator for the operation of FIG. 5. FIG. 6B is a diagram illustrating a mapping structure for operating a first submatrix multiplication among the mapping structures of FIG. 6A. FIG. 6C is a diagram illustrating a mapping structure for operating a second submatrix multiplication among the mapping structures of FIG. 6A.

FIG. 7 is a diagram illustrating a submatrix multiplication operation method to acquire matrix C using another method.

FIG. 8A is a diagram illustrating a first mapping structure used in the first submatrix multiplication operation in FIG. 7. FIG. 8B is a diagram illustrating a second mapping structure used in the second submatrix multiplication operation in FIG. 7.

FIG. 9 is a diagram illustrating the configuration of an artificial neural network processing apparatus according to another embodiment of the present disclosure in functional blocks.

FIG. 10 is a diagram for explaining a process for reading submatrix A1, which is first data.

FIG. 11 is a diagram for explaining a process for reading submatrix B1, which is first data.

FIG. 12 is a diagram for explaining a process for reading sub-matrices A3 and B2, which are second data.

FIG. 13 is a flowchart illustrating an artificial neural network processing method according to an embodiment of the present disclosure.

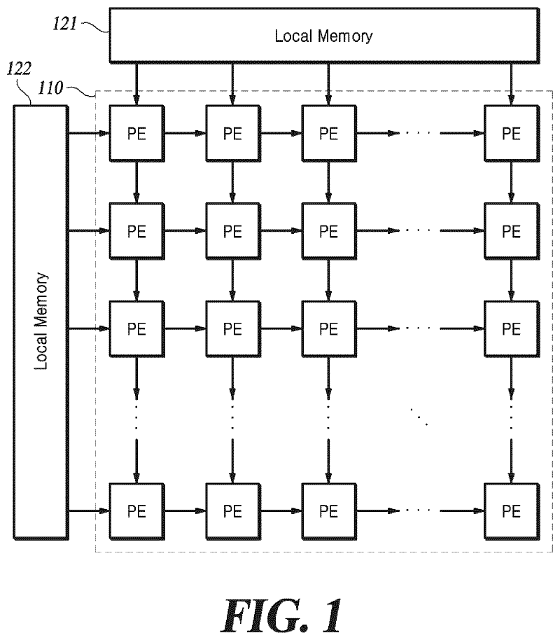

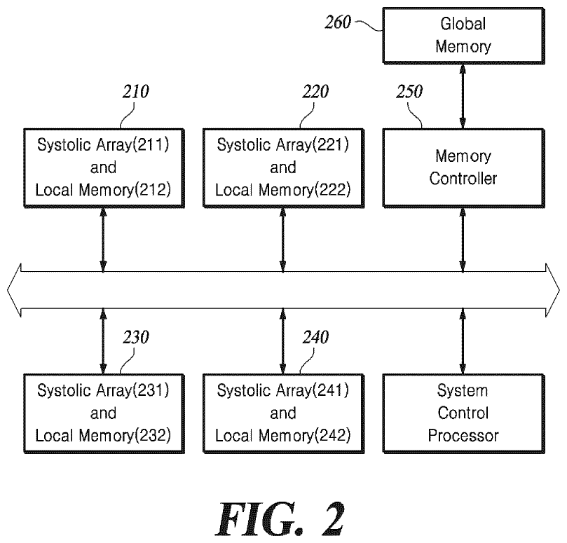

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity. Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof. The following detailed description, together with the accompanying drawings, is intended to describe exemplary embodiments of the present invention, and is not intended to represent the only embodiments in which the present invention may be practiced.

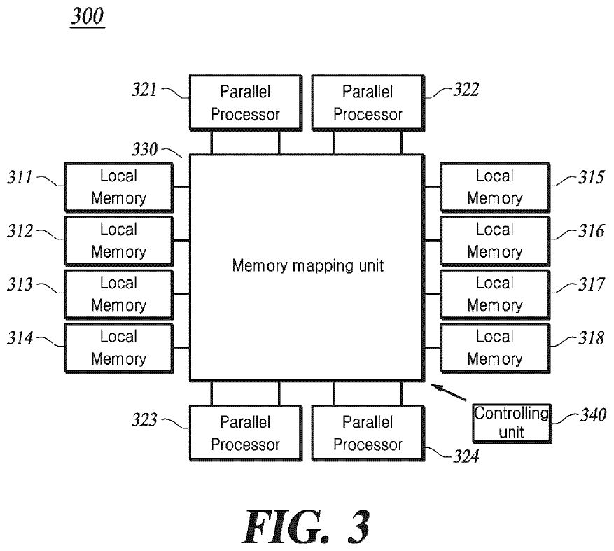

FIG. 3 is a diagram illustrating the configuration of an artificial neural network processing apparatus according to an embodiment of the present disclosure in functional blocks.

As illustrated in FIG. 3, an artificial neural network processing apparatus 300 according to an embodiment of the present disclosure including eight local memories 311, 312, 313, 314, 315, 316, 317, and 318, four submatrix multiplication operators 321, 322, 323, and 324, a memory mapping unit 330, and a controlling unit 340 may be implemented.

Eight local memories 311, 312, 313, 314, 315, 316, 317, and 318 each store input data for matrix multiplication operations. The controlling unit 340 reads matrix operation-related data from the global memory 260 and stores the same in eight local memories 311, 312, 313, 314, 315, 316, 317, and 318.

Four submatrix multiplication operators, in other words, first to fourth submatrix multiplication operators 321, 322, 323, and 324 use input data stored in eight local memories 311, 312, 313, 314, 315, 316, 317, and 318 to perform a first synchronized submatrix multiplication operation, and then perform a second synchronized submatrix multiplication operation. The controlling unit 340 controls the start time of the operation by sending a command to start the matrix multiplication operation of the first to fourth submatrix multiplication operators 321, 322, 323, and 324, and receives an operation completion message respectively from the first to fourth submatrix multiplication operators 321, 322, 323, and 324 when the first to fourth submatrix multiplication operators 321, 322, 323, and 324 complete the operation.

The submatrix multiplication operators 321, 322, 323, and 324 are each configured in the form of a systolic array, and a matrix multiplication operation is performed using input data from each pair of first and second input terminals (in other words, (a1, b1), (a2, b2), (a3, b3), and (a4, b4)).

The memory mapping unit 330 forms a mapping structure by mapping each local memory 311, 312, 313, 314, 315, 316, 317, or 318 to first to fourth submatrix multiplication operators 321, 322, 323, and 324 to perform the first submatrix multiplication operation and the second submatrix multiplication operation.

The memory mapping unit 330 maps the mapping structures between the eight local memories 311, 312, 313, 314, 315, 316, 317, and 318 and the first to fourth submatrix multiplication operators 321, 322, 323, and 324 to have different mapping structures when performing the first submatrix multiplication operation and when performing the second submatrix multiplication operation. The memory mapping unit 330 may be implemented with eight multiplexers (not shown) corresponding to each local memory 311, 312, 313, 314, 315, 316, 317, or 318, and each multiplexer (not shown) is controlled by the controlling unit 340 so that an output path is selected and connected to one of the two submatrix multiplication operators 321, 322, 323, and 324 for the corresponding local memory, thus generating a mapping structure in which the output path is formed.

In the following description, the meaning that the memory mapping unit 330 generates a mapping structure means that the mapping structure of the memory mapping unit 330 is generated under the control of the controlling unit 340.

In other words, the memory mapping unit 330 forms a first mapping structure by mapping eight local memories 311, 312, 313, 314, 315, 316, 317, and 318 to the first to fourth submatrix multiplication operators 321, 322, 323, and 324 for the first submatrix multiplication operation, and the first submatrix multiplication operation is started in the first to fourth submatrix multiplication operators 321, 322, 323, and 324 under the control of the controlling unit 340.

After receiving a completion message indicating that the first submatrix multiplication operation is completed respectively from the first to fourth submatrix multiplication operators 321, 322, 323, and 324, the controlling unit 340 generates a second mapping structure for the second submatrix multiplication operation. Even when the clocks of the first to fourth submatrix multiplication operators 321, 322, 323, and 324 are different from one another, synchronization for the start of the second submatrix multiplication operation may be achieved by using this completion message.

The memory mapping unit 330 forms a second mapping structure under the control of the controlling unit 340 for the second submatrix multiplication operation. In this connection, the memory mapping unit 330 maps eight local memories 311, 312, 313, 314, 315, 316, 317, and 318 to the first to fourth submatrix multiplication operators 321, 322, 323, and 324 to form a second mapping structure, wherein the first mapping structure and the second mapping structure are different mapping structures.

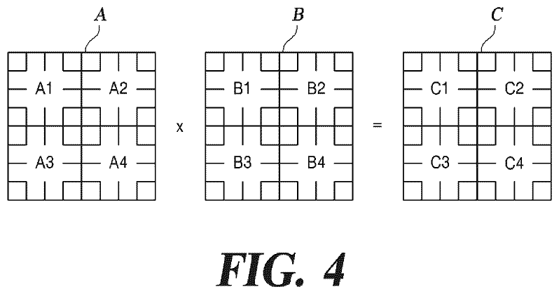

FIG. 4 is a diagram conceptually illustrating a matrix operation of multiplying matrix A and matrix B to acquire output matrix C.

In FIG. 4, input matrix A is configured of four square sub-matrices A1, A2, A3, and A4 of the same size, input matrix B is configured of four square sub-matrices B1, B2, B3, and B4 of the same size, and the output matrix C is configured of four square output sub-matrices C1, C2, C3, and C4 of the same size. Herein, a square matrix (or submatrix) means that the number of rows and the number of columns in the matrix are the same.

As illustrated in FIG. 4, based on the vertical and horizontal lines passing through the center of matrix A, submatrix A1 is located in the 2nd quadrant, submatrix A2 is located in the 1st quadrant, submatrix A3 is located in the 3rd quadrant, and submatrix A4 is located in the 4th quadrant.

Based on the vertical and horizontal lines passing through the center of matrix B, submatrix B1 is located in the 2nd quadrant, submatrix B2 is located in the 1st quadrant, submatrix B3 is located in the 3rd quadrant, and submatrix B4 is located in the 4th quadrant.

Based on the vertical and horizontal lines passing through the center of matrix C, output submatrix C1 is located in the second quadrant, output submatrix C2 is located in the first quadrant, output submatrix C3 is located in the third quadrant, and output submatrix C4 is located in the fourth quadrant.

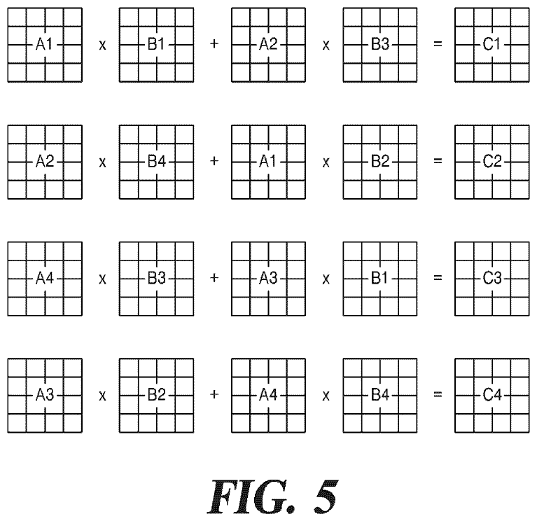

FIG. 5 is a diagram conceptually illustrating a submatrix multiplication operation method for acquiring the output matrix C.

The output submatrices C1, C2, C3, and C4 may be computed using the method shown in FIG. 5.

As illustrated in FIG. 5, the output sub-matrices C1, C2, C3, and C4 are calculated as the sum of two submatrix multiplication operations (in other words, a first submatrix multiplication operation and a second submatrix multiplication operation) and the results of each submatrix multiplication operation.

In other words, each first submatrix multiplication operation is performed at the same time as A1×B1, A2×B4, A4×B3, and A3×B2, and each second submatrix multiplication operation is A2×B3, A1×B2, A3×B1, and A4×B4 and is performed at the same time after each first submatrix multiplication operation. The sub-matrices C1, C2, C3, and C4 are calculated by adding the results of each first and second submatrix multiplication operation after each first submatrix multiplication operation and each second submatrix multiplication operation are performed.

In FIG. 5, the submatrices of matrices A and B used in each first submatrix multiplication operation are different from each other, and the submatrices of matrices A and B used in each second submatrix multiplication operation are different from each other.

In other words, the submatrices of matrix A used in each of the first submatrix multiplication operations A1×B1, A2×B4, A4×B3, and A3×B2 are different as A1, A2, A4, and A3, respectively. Additionally, the submatrices of matrix B used in A1×B1, A2×B4, A4×B3, and A3×B2 are different as B1, B4, B3, and B2, respectively.

Herein, eight local memories form a first mapping structure mapped to each input terminal a1, b1, a2, b2, a3, b3, a4, or b4 of different submatrix multiplication operators.

In addition, the submatrices of matrix A used in each of the second submatrix multiplication operations A2×B3, A1×B2, A3×B1, and A4×B4 are different as A2, A1, A3, and A4, respectively. In addition, the submatrices of matrix B used in each of the second submatrix multiplication operations A2×B3, A1×B2, A3×B1, and A4×B4 are different as B3, B2, B1, and B4, respectively.

Herein, for the second submatrix multiplication operation, a second mapping structure is formed in which eight local memories are mapped to each input terminal a1, b1, a2, b2, a3, b3, a4, or b4 of different submatrix multiplication operators. However, the first mapping structure and the second mapping structure are different from each other.

Submatrices A1 and A2 of matrix A are both used in the calculation of C1 and C2, but not in the calculation of C3 and C4, and submatrices A3 and A4 of matrix A are both used in the calculation of C3 and C4, but not in the calculation of C1 and C2. Submatrices B1 and B2 of matrix B are both used in the calculation of C1 and C3, but not in the calculation of C2 and C4, and submatrices B3 and B4 of matrix B are both used in the calculation of C2 and C4, but not in the calculation of C1 and C3.

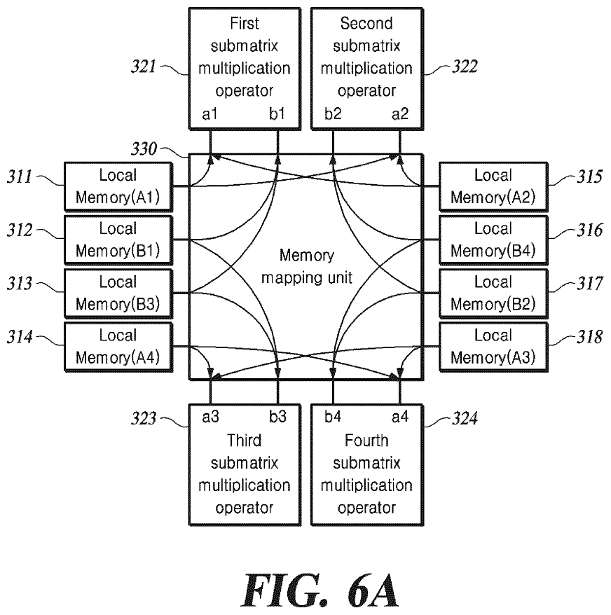

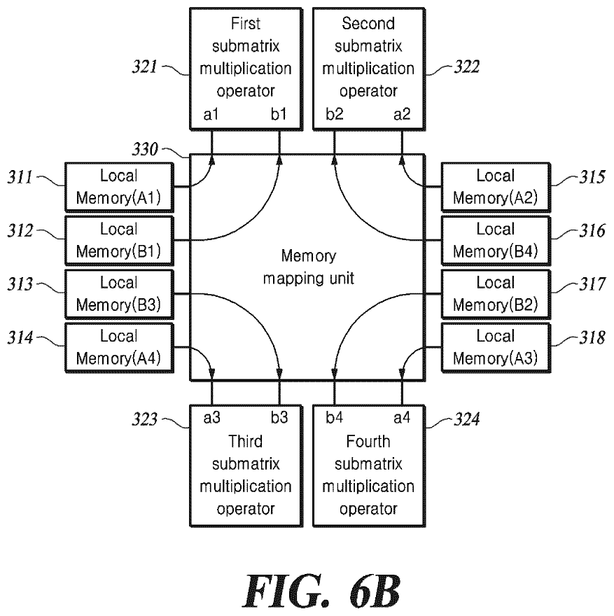

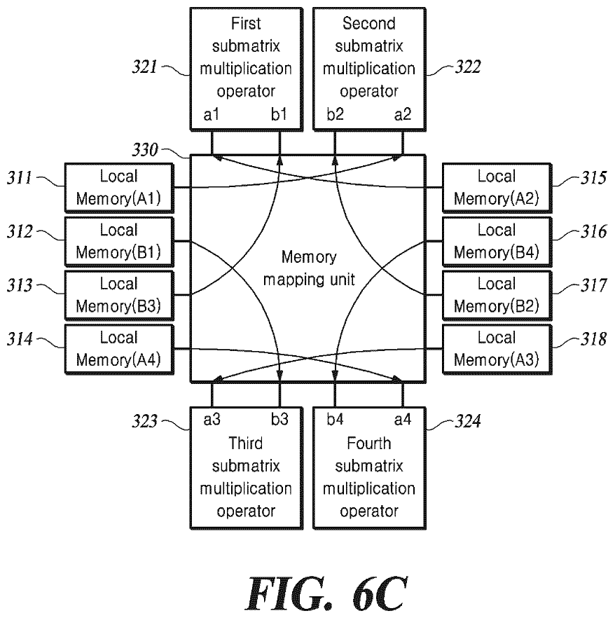

FIG. 6A is a diagram illustrating the mapping structure of a local memory and a submatrix multiplication operator for the operation of FIG. 5. FIG. 6B is a diagram illustrating a mapping structure for operating a first submatrix multiplication among the mapping structures of FIG. 6A. FIG. 6C is a diagram illustrating a mapping structure for operating a second submatrix multiplication among the mapping structures of FIG. 6A.

As illustrated in FIG. 6A, the memory mapping unit 330 according to a first embodiment enables effective matrix multiplication operation for the entire matrix by mapping each local memory 311, 312, 313, 314, 315, 316, 317, or 318 to different submatrix multiplication operators 321, 322, 323, and 324 for operating different types of submatrix multiplication.

In other words, as illustrated in FIG. 6B, the memory mapping unit 330 enables effective matrix multiplication operation for the entire matrix by mapping each local memory 311, 312, 313, 314, 315, 316, 317, or 318 to different submatrix multiplication operators 321, 322, 323, and 324 for operating different types of submatrix multiplication (that is, for operating the first submatrix multiplication and the second submatrix multiplication).

In other words, as illustrated in FIG. 6B, in order to operate the first synchronized submatrix multiplication, the memory mapping unit 330 maps a first memory 311 to a first input terminal a1 of a first submatrix multiplication operator 321, maps a second memory 312 to a second input terminal b1 of the first submatrix multiplication operator 321, maps a third memory 313 to a second input terminal b3 of a third submatrix multiplication operator 323, maps a fourth memory 314 to a first input terminal a3 of the third submatrix multiplication operator 323, maps a fifth memory 315 to a first input terminal a2 of a second submatrix multiplication operator 322, maps a sixth memory 316 to a second input terminal b2 of the second submatrix multiplication operator 322, maps a seventh memory 317 to a second input terminal b4 of a fourth submatrix multiplication operator 324, and maps an eighth memory 318 to a first input terminal a4 of the fourth submatrix multiplication operator 324.

In addition, as illustrated in FIG. 6C, in order to operate the second synchronized submatrix multiplication, the memory mapping unit 330 maps the first memory 311 to the first input terminal a2 of the second submatrix multiplication operator 322, maps the second memory 312 to the second input terminal b3 of the third submatrix multiplication operator 323, maps the third memory 313 to the second input terminal b1 of the first submatrix multiplication operator 321, maps the fourth memory 314 to the first input terminal a4 of the fourth submatrix multiplication operator 324, maps the fifth memory 315 to the first input terminal a1 of the first submatrix multiplication operator 321, maps the sixth memory 316 to the second input terminal b4 of the fourth submatrix multiplication operator 324, maps the seventh memory 317 to the second input terminal b2 of the second submatrix multiplication operator 322, and maps the eighth memory 318 to the first input terminal a3 of the third submatrix multiplication operator 323.

The submatrix multiplication operators 321, 322, 323, and 324 use each of the first input terminals a1, a2, a3, and a4 and the second input terminals b1, b2, b3, and b4 to perform each corresponding matrix multiplication operation.

The submatrix multiplication operators 321, 322, 323, and 324 use submatrix data input to each of the first input terminals a1, a2, a3, and a4 and the second input terminals b1, b2, b3, and b4. Since details on a method of performing each matrix multiplication operation are beyond the gist of the present disclosure, the detailed description thereof will be omitted.

As illustrated in FIGS. 6A to 6C, with only two types of mapping of the local memories 311, 312, 313, 314, 315, 316, 317, and 318 by the memory mapping unit 330, the multiplication operation of matrices A and B may be divided into submatrices and performed without data exchange among the local memories 311, 312, 313, 314, 315, 316, 317, and 318. Accordingly, the mapping structure for the matrix multiplication operation may be simply implemented and hardware resources may be minimized.

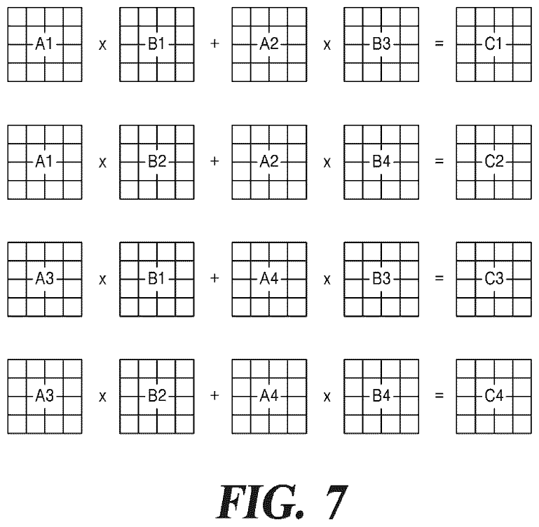

FIG. 7 is a diagram illustrating a submatrix multiplication operation method to acquire matrix C using another method.

In FIG. 7, in the first mapping structure used in the first submatrix multiplication operation, half of the total sub-matrices of each submatrix of matrix A and matrix B are used. In other words, A1 and A3, which correspond to half of the submatrices of matrix A, and B1 and B2, which correspond to half of the submatrices of matrix B, are used, when the first submatrix multiplication operations of A1×B1, A1×B2, A3×B1, and A3×B2 are operated.

In addition, submatrix A1 is used repeatedly when operating C1 and C2, and submatrix A3 is used repeatedly when operating C3 and C4. In addition, submatrix B1 of matrix B is used repeatedly when operating C1 and C3, and submatrix B2 is used repeatedly when operating C2 and C4.

The case of the second submatrix multiplication operation is similar to the case of the first submatrix multiplication operation. In the second mapping structure used in the second submatrix multiplication operation, half of the total sub-matrices are used for each submatrix of matrix A and matrix B. In other words, A2 and A4, which correspond to half of the submatrices of matrix A, and B3 and B4, which correspond to half of the submatrices of matrix B, are used, when the second submatrix multiplication operations of A2×B3, A2×B4, A4×B3, and A4×B4 are operated.

In addition, submatrix A2 is used repeatedly when operating C1 and C2, and submatrix A4 is used repeatedly when operating C3 and C4. In addition, submatrix B3 of matrix B is used repeatedly when operating C1 and C3, and submatrix B4 is used repeatedly when operating C2 and C4.

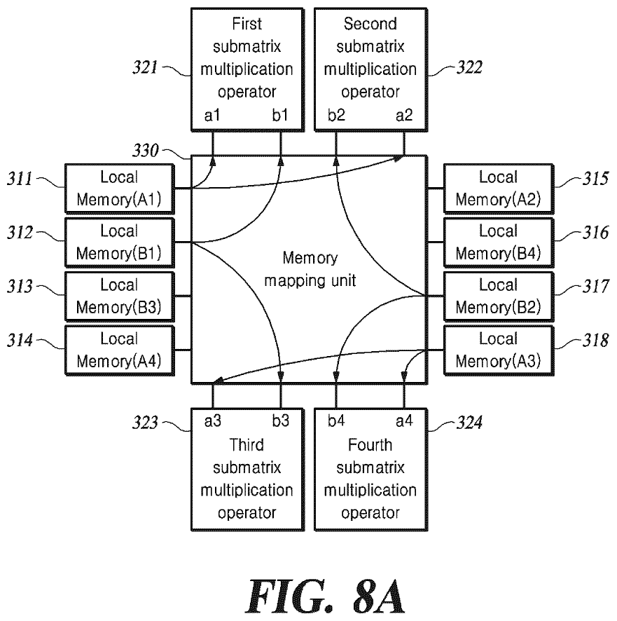

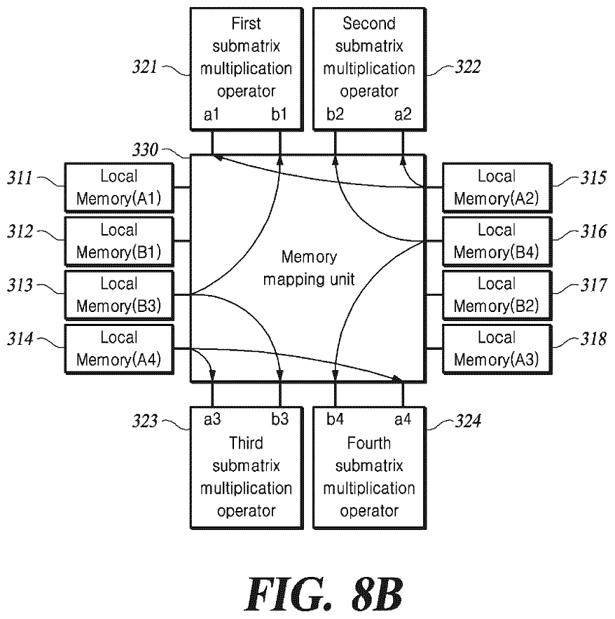

The memory mapping unit 330 may form a mapping structure in the same manner as FIGS. 8A and 8B using the features shown in FIG. 7.

FIG. 8A is a diagram illustrating a first mapping structure used in the first submatrix multiplication operation in FIG. 7. FIG. 8B is a diagram illustrating a second mapping structure used in the second submatrix multiplication operation in FIG. 7.

As illustrated in FIG. 8A, the memory mapping unit 330 according to a second embodiment forms a first mapping structure in which four local memories 311, 312, 317, and 318 are respectively mapped to inputs of first to fourth submatrix multiplication operators 321, 322, 323, and 324 for the first submatrix multiplication operation.

In the first mapping structure, a first local memory 311 is mapped to each of the first input terminals a1 and a2 of the first and second submatrix multiplication operators 321 and 322; a second local memory 312 is mapped to each of the second input terminals b1 and b3 of the first and third submatrix multiplication operators 321 and 323; a seventh local memory 317 is mapped to each of the second input terminals b2 and b4 of the second and forth submatrix multiplication operators 322 and 324; and a eighth local memory 318 is mapped to each of the first input terminals a3 and a4 of the third and fourth submatrix multiplication operators 323 and 324.

As illustrated in FIG. 8B, the memory mapping unit 330 forms a second mapping structure in which the remaining four local memories 313, 314, 315, and 316, excluding the four local memories 311, 312, 317, and 318 used during the first submatrix multiplication operation, are mapped to the input terminals of the first to fourth submatrix multiplication operators 321, 322, 323, and 324 for the second submatrix multiplication operation.

In the second mapping structure, a third local memory 313 is mapped to each of the second input terminals b1 and b3 of the first and third submatrix multiplication operators 321 and 323; a fourth local memory 314 is mapped to each of the first input terminals a3 and a4 of the third and fourth submatrix multiplication operators 323 and 324; a fifth local memory 315 is mapped to each of the first input terminals a1 and a2 of the first and second submatrix multiplication operators 321 and 322; and a sixth local memory 316 is mapped to each of the second input terminals b2 and b4 of the second and fourth submatrix multiplication operators 322 and 324.

As such, in the case of FIGS. 6A, 8A, and 8B, the memory mapping unit 330 provides two mapping structures according to the first and second embodiments, so that the multiplication operation of matrices A and B may be divided into submatrices and performed without data exchange among different local memories 311, 312, 313, 314, 315, 316, 317, and 318. In addition, the control logic of the memory mapping unit 330 therefor may be simply implemented, thereby minimizing the hardware resources required for the matrix multiplication operation.

In addition, as shown in FIGS. 8A and 8B, the memory mapping unit 330 according to the second embodiment uses only four memories in each of the first submatrix multiplication operation and the second submatrix multiplication operation. Hence, there is a benefit in that the number of local memories used simultaneously may be reduced by half compared to the case of the memory mapping unit 330 according to the first embodiment illustrated in FIG. 6A, so power consumption for the local memory may be reduced.

The artificial neural network processing apparatus 300 according to the aforementioned embodiment may be used in matrix multiplication operations where the operation matrix of the submatrix multiplication operators 321, 322, 323, and 324 and the local memories 311, 312, 313, 314, 315, 316, 317, and 318 are within a certain size.

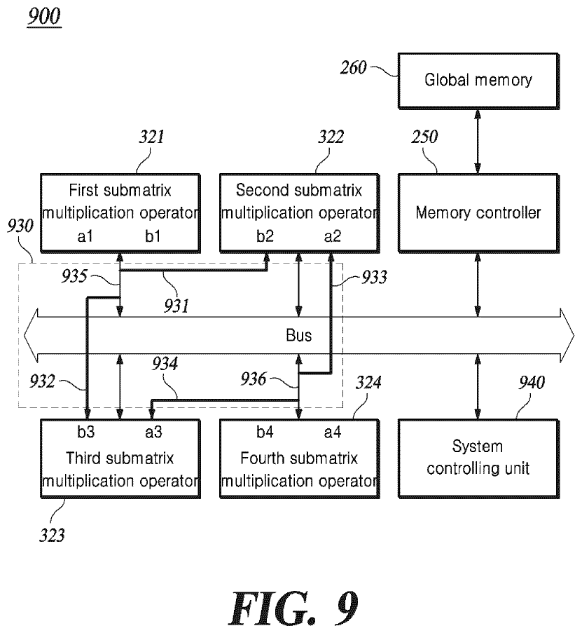

FIG. 9 is a diagram illustrating the configuration of an artificial neural network processing apparatus according to another embodiment of the present disclosure in functional blocks.

As illustrated in FIG. 9, an artificial neural network processing apparatus 900 according to another embodiment of the present disclosure may be implemented including first to fourth submatrix multiplication operators 321, 322, 323, and 324, a memory mapping unit 930, and a system controlling unit 940.

The matters regarding the action of the first to fourth submatrix multiplication operators 321, 322, 323, and 324 have been described in the description of the artificial neural network processing apparatus 300 according to the first embodiment, so further description thereof is omitted.

However, in the artificial neural network processing apparatus 300 according to the first embodiment, the first to fourth submatrix multiplication operators 321, 322, 323, and 324 perform the first synchronized submatrix multiplication operation using input data stored in eight external local memories 311, 312, 313, 314, 315, 316, 317, and 318 and then perform the second synchronized submatrix multiplication operation. However, in the artificial neural network processing apparatus 900 according to the second embodiment, two local memories are implemented in each of the first to fourth submatrix multiplication operators 321, 322, 323, and 324, and the first submatrix multiplication operation and the second submatrix multiplication operation are performed using a total of eight local memories.

The memory mapping unit 930 may be implemented including a first broadcasting unit 931, a second broadcasting unit 932, a third broadcasting unit 933, a fourth broadcasting unit 934, a first selecting unit 935, and a second selecting unit 936.

The first broadcasting unit 931 broadcasts the first data transmitted to the first submatrix multiplication operator 321 to the second submatrix multiplication operator 322; the second broadcasting unit 932 broadcasts the first data transmitted to the second submatrix multiplication operator 322 to the third submatrix multiplication operator 323; the third broadcasting unit 933 broadcasts the second data transmitted to the fourth submatrix multiplication operator 324 to the second submatrix multiplication operator 322; and the fourth broadcasting unit 934 broadcasts the second data transmitted to the fourth submatrix multiplication operator 324 to the third submatrix multiplication operator 323.

The controlling unit in this embodiment, in other words, the system controlling unit 940, transmits the first data, first matrix multiplication information, and first selection information to the first selecting unit 935, and transmits the second data, second matrix multiplication information, and second selection information to the second selecting unit 936.

The system controlling unit 940 provides information about the first data, first matrix multiplication information, and first selection information to the memory controller 250 so that the memory controller 250 is controlled to transmit the first data, first matrix multiplication information, and first selection information to the first selecting unit 935. In this connection, the memory controller 250 accesses the global memory 260 to acquire the first data.

In addition, the system controlling unit 940 provides information about the second data, second matrix multiplication information, and second selection information to the memory controller 250 so that the memory controller 250 is controlled to transmit the second data, second matrix multiplication information, and second selection information to the second selecting unit 936. In this connection, the memory controller 250 accesses the global memory 260 to acquire the second data.

When the first data is transmitted to the first selecting unit 935 under the control of the system controlling unit 940, the first selecting unit 935 delivers the first data and first matrix multiplication information to the first submatrix multiplication operator 321, and select one of the first broadcasting unit 931 and the second broadcasting unit 932 for broadcasting the first data. Herein, the first matrix multiplication information includes information identifying a specific input terminal of the first submatrix multiplication operator 321.

In addition, when the second data is transmitted to the second selecting unit 936 under the control of the system controlling unit 940, the second selecting unit 936 delivers the second data and second matrix multiplication information to the fourth submatrix multiplication operator 324, and select one of the third broadcasting unit 933 and the fourth broadcasting unit 934 for broadcasting the second data. Herein, the second matrix multiplication information includes information identifying a specific input terminal of the fourth submatrix multiplication operator 324.

As described above, the system controlling unit 940 transmits the first data, first matrix multiplication information, and first selection information to the first selecting unit 935 and transmits the second data, second matrix multiplication information, and second selection information to the second selecting unit 936.

The first selecting unit 935 selects one of the first broadcasting unit 931 and the second broadcasting unit 932 based on the first selection information.

The second selecting unit 936 selects one of the third broadcasting unit 933 and the fourth broadcasting unit 934 based on the second selection information.

Herein, the first selecting unit 935 may include one multiplexer to select one of the first broadcasting unit 931 and the second broadcasting unit 932, and the second selecting unit 936 may include another multiplexer to select one of the third broadcasting unit 933 and the fourth broadcasting unit 934, without being limited thereto.

The broadcasted first data or second data is set to be input to a specific input terminal for a matrix multiplication operation in a submatrix multiplication operator corresponding to each broadcasting destination.

In other words, the output of the first broadcasting unit 931 is connected to the first input terminal a2 of the second submatrix multiplication operator 322; the output of the second broadcasting unit 932 is connected to the second input terminal b3 of the third submatrix multiplication operator 323; the output of the third broadcasting unit 933 is connected to the second input terminal b2 of the second submatrix multiplication operator 322; and the output of the fourth broadcasting unit 934 is connected to the first input terminal a3 of the third submatrix multiplication operator 323.

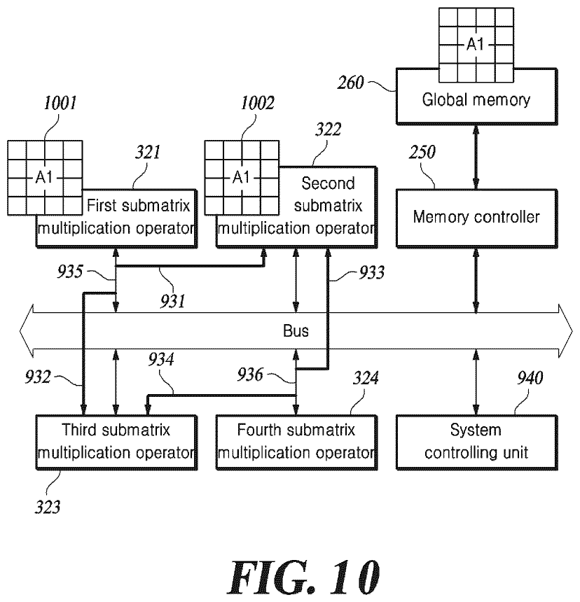

FIG. 10 is a diagram for explaining a process for reading submatrix A1, which is first data.

The system controlling unit 940 transmits information about first data A1, the first matrix multiplication information, and the first selection information to the memory controller 250 in order to read submatrix A1, which is the first data. In this connection, the first selection information includes information indicating the first broadcasting unit 931, and the first matrix multiplication information includes information meaning the first input terminal a1 of the first submatrix multiplication operator 321.

The memory controller 250 reads A1 from the global memory 260 and transmits the A1 to the first selecting unit 935 together with the first matrix multiplication information and the first selection information.

In this connection, the first selecting unit 935 transmits the A1 and the first matrix multiplication information to the first submatrix multiplication operator 321, and the first submatrix multiplication operator 321 stores the A1 in a local memory 1001 corresponding to the first input terminal a1 of the first submatrix multiplication operator 321 based on the first matrix multiplication information.

In addition, the first selecting unit 935 inputs the first data A1 to the first broadcasting unit 931 corresponding to the first selection information. In this connection, the first broadcasting unit 931 into which A1 is input is connected to the first input terminal a2 of the second submatrix multiplication operator 322 so that the A1 is output. In this connection, the second submatrix multiplication operator 322 stores A1 in a local memory 1002 corresponding to the first input terminal a2 so that the A1 is connected to the first input terminal a2.

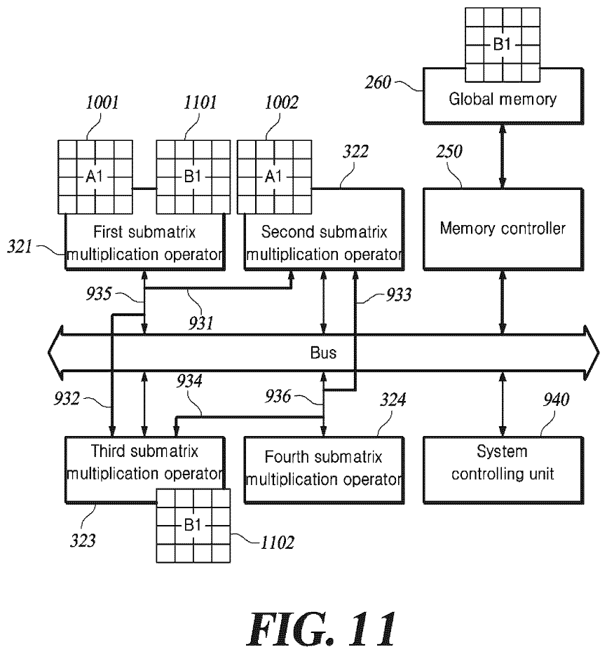

FIG. 11 is a diagram for explaining a process for reading submatrix B1, which is first data.

The system controlling unit 940 transmits information about first data B1, the first matrix multiplication information, and the first selection information to the memory controller 250 in order to read submatrix B1, which is the first data. In this connection, the first selection information includes information indicating the second broadcasting unit 932, and the first matrix multiplication information includes information meaning the second input terminal b1 of the first submatrix multiplication operator 321.

The memory controller 250 reads B1 from the global memory 260 and transmits the B1 to the first selecting unit 935 together with the first matrix multiplication information and the first selection information.

In this connection, the first selecting unit 935 transmits the B1 and the first matrix multiplication information to the first submatrix multiplication operator 321, and the first submatrix multiplication operator 321 stores the B1 in a local memory 1001 corresponding to the second input terminal b1 of the first submatrix multiplication operator 321 based on the first matrix multiplication information.

In addition, the first selecting unit 935 inputs the first data B1 to the first broadcasting unit 931 corresponding to the first selection information. In this connection, the second broadcasting unit 932 into which B1 is input is connected to the second input terminal b3 of the third submatrix multiplication operator 323 so that the B1 is output. In this connection, the third submatrix multiplication operator 323 stores B1 in a local memory 1102 corresponding to the second input terminal b3 so that the B1 is connected to the second input terminal b3.

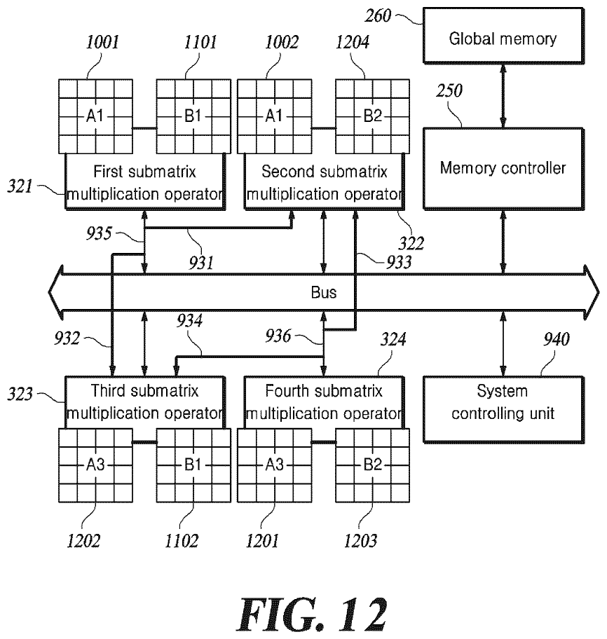

FIG. 12 is a diagram for explaining a process for reading sub-matrices A3 and B2, which are second data.

The system controlling unit 940 transmits information about second data A3, the second matrix multiplication information, and the second selection information to the memory controller 250 in order to read submatrix A3, which is the second data. In this connection, the second selection information includes information indicating the fourth broadcasting unit 934, and the second matrix multiplication information includes information meaning the first input terminal a4 of the fourth submatrix multiplication operator 324.

The memory controller 250 reads A3 from the global memory 260 and transmits the A3 to the second selecting unit 936 together with the second matrix multiplication information and the second selection information.

In this connection, the second selecting unit 936 transmits the A3 and the second matrix multiplication information to the fourth submatrix multiplication operator 324, and the fourth submatrix multiplication operator 321 stores the A3 in a local memory 1201 corresponding to the first input terminal a4 of the fourth submatrix multiplication operator 324 based on the second matrix multiplication information.

In addition, the second selecting unit 936 inputs the second data A3 to the fourth broadcasting unit 934 corresponding to the second selection information. In this connection, the fourth broadcasting unit 934 into which A3 is input is connected to the first input terminal a3 of the third submatrix multiplication operator 323 so that the A3 is output. In this connection, the third submatrix multiplication operator 323 stores A3 in a local memory 1202 corresponding to the first input terminal a3 so that the A3 is connected to the first input terminal a3.

The system controlling unit 940 transmits information about second data B2, the second matrix multiplication information, and the second selection information to the memory controller 250 in order to read submatrix B2, which is the second data. In this connection, the second selection information includes information indicating the third broadcasting unit 933, and the second matrix multiplication information includes information meaning the second input terminal b4 of the fourth submatrix multiplication operator 324.

The memory controller 250 reads B2 from the global memory 260 and transmits the B2 to the second selecting unit 936 together with the second matrix multiplication information and the second selection information.

In this connection, the second selecting unit 93 transmits the B2 and the second matrix multiplication information to the fourth submatrix multiplication operator 324, and the fourth submatrix multiplication operator 324 stores the B2 in a local memory 1203 corresponding to the second input terminal b4 of the fourth submatrix multiplication operator 324 based on the second matrix multiplication information.

In addition, the second selecting unit 936 inputs the second data B2 to the third broadcasting unit 933 corresponding to the second selection information. In this connection, the third broadcasting unit 933 into which B2 is input is connected to the second input terminal b2 of the second submatrix multiplication operator 322 so that the B2 is output. In this connection, the second submatrix multiplication operator 322 stores B2 in a local memory 1204 corresponding to the second input terminal b2 so that the B2 is connected to the second input terminal b2.

The operation of FIG. 12 illustrates the first submatrix multiplication operation A1×B1, A1×B2, A3×B1, and A3×B2. After the operation corresponding to FIG. 12 is completed, the artificial neural network processing apparatus 900 reads the submatrix corresponding to the second submatrix multiplication operation from the local memory 260, stores the same in the local memories 1001, 1002, 1101, 1102, 1201, 1202, 1203, and 1204, and performs the second submatrix multiplication operation A2×B3, A2×B4, A4×B3, and A4×B4.

In the artificial neural network processing apparatus 900, the first data sub-matrices A2 and B3, and the second data sub-matrices A4 and B4 are read for the second submatrix multiplication operation A2×B3, A2×B4, A4×B3, and A4×B4 in a similar manner to the first submatrix multiplication operation A1×B1, A1×B2, A3×B1, and A3×B2.

The system controlling unit 940 transmits information about the first data A2, the first matrix multiplication information, and the first selection information to the memory controller 250 in order to read submatrix A2, which is the first data. In this connection, the first selection information includes information indicating the first broadcasting unit 931, and the first matrix multiplication information includes information meaning the first input terminal a1 of the first submatrix multiplication operator 321.

The memory controller 250 reads A2 from the global memory 260 and transmits the A2 to the first selecting unit 935 together with the first matrix multiplication information and the first selection information.

In this connection, the first selecting unit 935 transmits the A2 and the first matrix multiplication information to the first submatrix multiplication operator 321, and the first submatrix multiplication operator 321 stores the A2 in the local memory 1001 corresponding to the first input terminal a1 of the first submatrix multiplication operator 321 based on the first matrix multiplication information.

In addition, the first selecting unit 935 inputs the first data A2 to the first broadcasting unit 931 corresponding to the first selection information. In this connection, the first broadcasting unit 931 into which A2 is input is connected to the first input terminal a2 of the second submatrix multiplication operator 322 so that the A2 is output. In this connection, the second submatrix multiplication operator 322 stores A2 in the local memory 1002 corresponding to the first input terminal a2 so that the A2 is connected to the first input terminal a2.

The system controlling unit 940 transmits information about the first data B3, the first matrix multiplication information, and the first selection information to the memory controller 250 in order to read submatrix B3, which is the first data. In this connection, the first selection information includes information indicating the second broadcasting unit 932, and the first matrix multiplication information includes information meaning the second input terminal b1 of the first submatrix multiplication operator 321.

The memory controller 250 reads B3 from the global memory 260 and transmits the B3 to the first selecting unit 935 together with the first matrix multiplication information and the first selection information.

In this connection, the first selecting unit 935 transmits the B3 and the first matrix multiplication information to the first submatrix multiplication operator 321, and the first submatrix multiplication operator 321 stores the B3 in the local memory 1001 corresponding to the second input terminal b1 of the first submatrix multiplication operator 321 based on the first matrix multiplication information.

In addition, the first selecting unit 935 inputs the first data B3 to the second broadcasting unit 932 corresponding to the first selection information. In this connection, the second broadcasting unit 932 into which B3 is input is connected to the second input terminal b3 of the third submatrix multiplication operator 323 so that the B3 is output. In this connection, the third submatrix multiplication operator 323 stores B3 in the local memory 1102 corresponding to the second input terminal b3 so that the B3 is connected to the second input terminal b3.

The system controlling unit 940 transmits information about second data A4, the second matrix multiplication information, and the second selection information to the memory controller 250 in order to read submatrix A4, which is the second data. In this connection, the second selection information includes information indicating the fourth broadcasting unit 934, and the second matrix multiplication information includes information meaning the first input terminal a4 of the fourth submatrix multiplication operator 324.

The memory controller 250 reads A4 from the global memory 260 and transmits the A4 to the second selecting unit 936 together with the second matrix multiplication information and the second selection information.

In this connection, the second selecting unit 936 transmits the A4 and the second matrix multiplication information to the fourth submatrix multiplication operator 324, and the fourth submatrix multiplication operator 324 stores the A4 in the local memory 1201 corresponding to the first input terminal a4 of the fourth submatrix multiplication operator 324 based on the second matrix multiplication information.

In addition, the second selecting unit 936 inputs the second data A4 to the fourth broadcasting unit 934 corresponding to the second selection information. In this connection, the fourth broadcasting unit 934 into which A4 is input is connected to the first input terminal a3 of the third submatrix multiplication operator 323 so that the A4 is output. In this connection, the third submatrix multiplication operator 323 stores A4 in the local memory 1202 corresponding to the first input terminal a3 so that the A4 is connected to the first input terminal a3.

The system controlling unit 940 transmits information about second data B4, the second matrix multiplication information, and the second selection information to the memory controller 250 in order to read submatrix A4, which is the second data. In this connection, the second selection information includes information indicating the third broadcasting unit 933, and the second matrix multiplication information includes information meaning the second input terminal b4 of the fourth submatrix multiplication operator 324.

The memory controller 250 reads B4 from the global memory 260 and transmits the B4 to the second selecting unit 936 together with the second matrix multiplication information and the second selection information.

In this connection, the second selecting unit 936 transmits the B4 and the second matrix multiplication information to the fourth submatrix multiplication operator 324, and the fourth submatrix multiplication operator 324 stores the B4 in the local memory 1203 corresponding to the second input terminal b4 of the fourth submatrix multiplication operator 324 based on the second matrix multiplication information.

In addition, the first selecting unit 936 inputs the second data B4 to the third broadcasting unit 933 corresponding to the second selection information. In this connection, the third broadcasting unit 933 into which B4 is input is connected to the second input terminal b2 of the second submatrix multiplication operator 322 so that the B4 is output. In this connection, the second submatrix multiplication operator 322 stores B4 in the local memory 1204 corresponding to the second input terminal b2 so that the B4 is connected to the second input terminal b2.

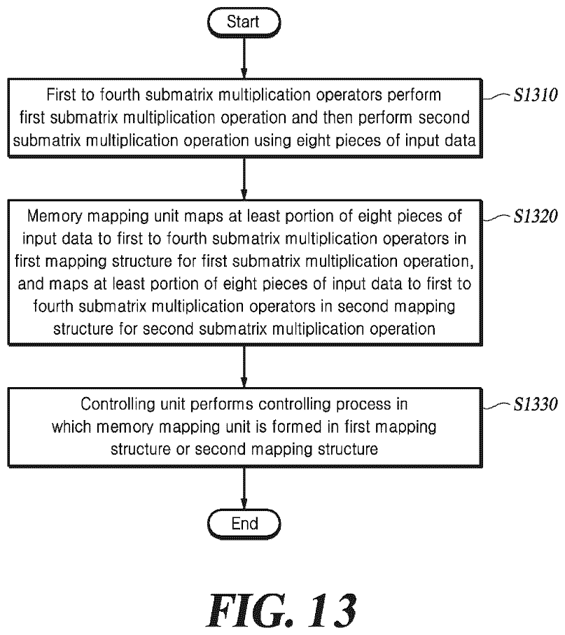

FIG. 13 is a flowchart illustrating an artificial neural network processing method according to an embodiment of the present disclosure.

An artificial neural network processing method according to one embodiment of the present disclosure, is performed by the artificial neural network processing apparatus 300 or 900 according to the first or second embodiment.

The first to fourth submatrix multiplication operators 321, 322, 323, and 324 perform a first submatrix multiplication operation, and then perform a second submatrix multiplication operation, by using eight pieces of input data (S1310).

The memory mapping unit 330 or 930 performs a memory mapping process in which at least a portion of eight pieces of input data is mapped to the first to fourth submatrix multiplication operators 321, 322, 323, and 324 in a first mapping structure for the first submatrix multiplication operation, and in which at least a portion of eight pieces of input data is mapped to the first to fourth submatrix multiplication operators 321, 322, 323, and 324 in a second mapping structure for the second submatrix multiplication operation, but the first mapping structure and the second mapping structure have different mapping structures (S1320).

The controlling unit 340 or 940 performs a controlling process in which the memory mapping unit 330 or 930 is formed in the first mapping structure or the second mapping structure (S1330).

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents. Accordingly, one of ordinary skill would understand that the scope of the claimed invention is not to be limited by the above explicitly described embodiments but by the claims and equivalents thereof.

What is claimed is:

1. An artificial neural network processing apparatus comprising:
first to fourth submatrix multiplication operators configured to perform a first submatrix multiplication operation and then a second submatrix multiplication operation using eight pieces of input data;
a memory mapping unit configured to map at least a portion of the eight pieces of input data to the first to fourth submatrix multiplication operators with a first mapping structure for the first submatrix multiplication operation, and maps at least a portion of the eight pieces of input data to the first to fourth submatrix multiplication operators with a second mapping structure for the second submatrix multiplication operation, wherein the first mapping structure and the second mapping structure have different mapping structures; and
a controlling unit configured to control the memory mapping unit to be formed with the first mapping structure or the second mapping structure.

2. The apparatus of claim 1, further comprising eight local memories each storing the eight pieces of input data,
wherein the memory mapping unit forms the first mapping structure by mapping the eight local memories to the first to fourth submatrix multiplication operators for the first submatrix multiplication operation, and forms the second mapping structure by mapping the eight local memories to the first to fourth submatrix multiplication operators for the second submatrix multiplication operation.

3. The apparatus of claim 2, wherein the memory mapping unit forms the first mapping structure in which the eight local memories are each mapped to each input terminal of different submatrix multiplication operators respectively, for the first submatrix multiplication operation.

4. The apparatus of claim 3, wherein the memory mapping unit forms the second mapping structure that is mapped to the input terminal of a submatrix multiplication operator, which is different from that of the first submatrix multiplication operation, for each of the eight local memories for the second submatrix multiplication operation.

5. The apparatus of claim 2, wherein the memory mapping unit forms the first mapping structure in which four local memories are each mapped to input terminals of the first to fourth submatrix multiplication operators respectively, for the first submatrix multiplication operation.

6. The apparatus of claim 5, wherein the memory mapping unit forms the second mapping structure in which the remaining four local memories, excluding the four local memories, are each mapped to the input terminals of the first to fourth submatrix multiplication operators respectively, for the second submatrix multiplication operation.

7. The apparatus of claim 2, wherein the memory mapping unit comprises eight multiplexers, each of which has an output path selected from among two submatrix multiplication operators for a corresponding local memory to generate the first mapping structure or the second mapping structure.

8. The apparatus of claim 7, wherein the controlling unit controls the eight multiplexers so that the memory mapping unit has the first mapping structure, and controls the same so that the memory mapping unit has the second mapping structure after receiving matrix multiplication operation completion messages from each of the first to fourth submatrix multiplication operators.

9. The apparatus of claim 1, wherein the memory mapping unit comprises a first, a second, a third, and a fourth broadcasting unit, wherein:
the first broadcasting unit broadcasts first data transmitted to the first submatrix multiplication operator to the second submatrix multiplication operator;
the second broadcasting unit broadcasts the first data transmitted to the first submatrix multiplication operator to the third submatrix multiplication operator;
the third broadcasting unit broadcasts second data to the second submatrix multiplication operator; and
the fourth broadcasting unit broadcasts the second data to the third submatrix multiplication operator.

10. The apparatus of claim 9, further comprising a first selecting unit and a second selecting unit, wherein:
when the controlling unit transmits the first data to the first selecting unit, the first selecting unit delivers the first data to the first submatrix multiplication operator and selects one of the first broadcasting unit and the second broadcasting unit for broadcasting the first data; and
when the controlling unit transmits the second data to the second selecting unit, the second selecting unit delivers the second data to the fourth submatrix multiplication operator and selects one of the third broadcasting unit and the fourth broadcasting unit for broadcasting the second data.

11. The apparatus of claim 10, wherein:
the first selecting unit selects one of the first broadcasting unit and the second broadcasting unit for broadcasting the first data based on first selection information transmitted together with the first data; and
the second selecting unit selects one of the third broadcasting unit and the fourth broadcasting unit for broadcasting the second data based on second selection information transmitted together with the second data.

12. The apparatus of claim 10, wherein at least one of the first, second, third and fourth broadcasting units is set to be input to a specific input terminal of a corresponding submatrix multiplication operator.

13. A method for processing an artificial neural network in an artificial neural network processing apparatus comprising first to fourth submatrix multiplication operators, a memory mapping unit, and a controlling unit, the method comprising:
a process of performing a first submatrix multiplication operation and then a second submatrix multiplication operation using eight pieces of input data in the first to fourth submatrix multiplication operators;
a memory mapping process in which the memory mapping unit maps at least a portion of the eight pieces of input data to the first to fourth submatrix multiplication operators with a first mapping structure for the first submatrix multiplication operation, and maps at least a portion of the eight pieces of input data to the first to fourth submatrix multiplication operators with a second mapping structure for the second submatrix multiplication operation, wherein the first mapping structure and the second mapping structure have different mapping structures; and
a controlling process in which the controlling unit controls the memory mapping unit to be formed with the first mapping structure or the second mapping structure.

14. The method of claim 13, wherein the artificial neural network processing apparatus further comprises eight local memories each storing the eight pieces of input data, wherein the memory mapping process forms the first mapping structure by mapping the eight local memories to the first to fourth submatrix multiplication operators for the first submatrix multiplication operation, and forms the second mapping structure by mapping the eight local memories to the first to fourth submatrix multiplication operators for the second submatrix multiplication operation.

15. The method of claim 14, wherein the memory mapping process forms the first mapping structure in which four local memories are each mapped to input terminals of the first to fourth submatrix multiplication operators respectively, for the first submatrix multiplication operation.

16. The method of claim 15, wherein the memory mapping process forms the second mapping structure in which the remaining four local memories, excluding the four local memories, are each mapped to the input terminals of the first to fourth submatrix multiplication operators respectively, for the second submatrix multiplication operation.

17. The method of claim 14, wherein:
the memory mapping unit comprises eight multiplexers;
and the memory mapping process is configured such that each of the multiplexers has an output path selected from among two submatrix multiplication operators for a corresponding local memory to generate the first mapping structure or the second mapping structure.

18. The method of claim 13, wherein the memory mapping unit comprises a first, a second, a third, and a fourth broadcasting unit, wherein:
the first broadcasting unit broadcasts first data transmitted to the first submatrix multiplication operator to the second submatrix multiplication operator;
the second broadcasting unit broadcasts the first data transmitted to the first submatrix multiplication operator to the third submatrix multiplication operator;
the third broadcasting unit broadcasts second data to the second submatrix multiplication operator; and
the fourth broadcasting unit broadcasts the second data to the third submatrix multiplication operator.

19. The method of claim 18, wherein the artificial neural network processing apparatus further comprises a first selecting unit and a second selecting unit, wherein:
when the controlling unit transmits the first data to the first selecting unit, the first selecting unit delivers the first data to the first submatrix multiplication operator and selects one of the first broadcasting unit and the second broadcasting unit for broadcasting the first data; and
when the controlling unit transmits the second data to the second selecting unit, the second selecting unit delivers the second data to the fourth submatrix multiplication operator and selects one of the third broadcasting unit and the fourth broadcasting unit for broadcasting the second data.

20. The method of claim 19, wherein:
the first selecting unit selects one of the first broadcasting unit and the second broadcasting unit for broadcasting the first data based on first selection information transmitted together with the first data; and
the second selecting unit selects one of the third broadcasting unit and the fourth broadcasting unit for broadcasting the second data based on second selection information transmitted together with the second data.
